(19) United States
(12) Patent Application Publication
(10) Pub. No.: US 2015/0138251 A1
(43) Pub. Date: May 21, 2015

(54) METHOD OF CONTROLLING LUMINANCE, LUMINANCE CONTROLLER, AND ORGANIC LlGHT-EMITTING DIODE (OLED) DISPLAY INCLUDING THE SAME

(71) Applicant: Samsung Display Co., Ltd., Yongin-City (KR)

(72) Inventor: Si-Beak Pyo, Cheonan-si (KR)

(21) Appl. No.: 14/487,724

(22) Filed: Sep. 16, 2014

(30) Foreign Application Priority Data
Nov. 18, 2013 (KR) 10-2013-0139605

(51) Int. Cl. G09G 5/10; G09G 5/18; G09G 3/32

(52) U.S. Cl. CPC G09G 5/10; G09G 3/3275; G09G 5/18
USPC 345/690; 345/82

(57) ABSTRACT

A method of controlling a luminance, a luminance controller, and an organic light-emitting diode (OLED) display are disclosed. In one aspect, a luminance data to be displayed on a display panel is received from an external device. A gamma group corresponding to the luminance data is selected among a plurality of gamma groups, each gamma group including a plurality of gamma data. A dimming data corresponding to the selected gamma group is retrieved. The selected gamma group is output to a data driver and the dimming data is output to an emission controller.

### CROSS-REFERENCE TO RELATED APPLICATIONS

This application claims priority under 35 USC §119 to Korean Patent Applications No. 10-2013-0139605, filed on Nov. 18, 2013 in the Korean Intellectual Property Office (KIPO), the contents of which are incorporated herein in its entirety by reference.

### BACKGROUND

1. Field

The described technology generally relates to an organic light-emitting diode (OLED) display.

2. Description of the Related Technology

A flat panel display (FPD) is widely used as a display because it is lightweight and thin compared to a cathode ray tube (CRT) display. Typical examples of the FPD technologies are liquid-crystal display (LCD) and organic light-emitting diode (OLED). Compared to LCDs, OLED displays have a higher luminance and a wider viewing angle. In addition, the OLED display can have a very slim profile because it does not require a backlight. In OLED pixels, electrons and holes are injected into an organic layer through a cathode and an anode, and recombined to generate excitons, thereby emitting light. Recently, a dimming technique that changes the luminance of the OLED display by controlling a light emission time has gained popularity.

### SUMMARY OF CERTAIN INVENTIVE ASPECTS

One inventive aspect is a method of controlling luminance, a luminance controller, and an organic light-emitting diode (OLED) display.

Another aspect is a method of controlling a luminance that can provide a gamma group (i.e., a data voltage) and a dimming data that corresponds to each luminance in an organic light-emitting display device that can change the luminance.

Another aspect is a luminance control unit that can provide a gamma group (i.e., a data voltage) and a dimming data that correspond to each luminance in an organic light-emitting display device that can change the luminance.

Another aspect is an organic light-emitting display device including the luminance control unit capable of displaying a high-quality image.

Another aspect is a method of controlling a luminance that includes an operation of receiving luminance data to be displayed on a display panel from an external device, an operation of selecting a gamma group corresponding to the luminance data among a plurality of gamma groups each including a plurality of gamma data, an operation of importing dimming data corresponding to the selected gamma group, and an operation of outputting the selected gamma group to a data driving unit and the dimming data to an emission control unit.

In example embodiments, the luminance data may be data by which a maximum luminance is displayed on the display panel.

In example embodiments, the selected gamma group may be a gamma group of which a feasible maximum luminance corresponds to the luminance data among the gamma groups.

In example embodiments, a dimming operation of the display panel may be performed based on the dimming data, and the dimming data may be an off duty ratio that controls a light emission time of an organic light-emitting diode of the display panel.

In example embodiments, the dimming operation may correspond to a global dimming operation, and the dimming operation may be simultaneously performed on an entire region of the display panel.

In example embodiments, the dimming operation may correspond to a local dimming operation, and the dimming operation may be separately performed on respective regions of the display panel.

Another aspect is a luminance control unit that includes a gamma group selecting unit configured to receive luminance data to be displayed on a display panel from an external device, and to select a gamma group corresponding to the luminance data among a plurality of gamma groups each including a plurality of gamma data, a gamma group storing unit configured to store the gamma groups, and a dimming data storing unit configured to store a plurality of dimming data corresponding to each of gamma groups.

In example embodiments, the luminance data may be data by which a maximum luminance is displayed on the display panel.

In example embodiments, the selected gamma group may be the gamma group of which a feasible maximum luminance corresponds to the luminance data among the gamma groups.

In example embodiments, a dimming operation of the display panel may be performed based on the dimming data, and the dimming data may be an off duty ratio that controls a light emission time of an organic light-emitting diode of the display panel.

Another aspect is an organic light-emitting display device that includes a display panel including a plurality of pixels each having an organic light-emitting diode, a data driving unit configured to provide a data signal to the pixels, a scan driving unit configured to provide a scan signal SCAN to the pixels, an emission control unit configured to provide an emission control signal to the pixels, a power unit configured to provide a high power voltage and a low power voltage to the pixels, a timing control unit configured to control the scan driving unit, the data driving unit, the emission control unit, and the power unit, and a luminance control unit configured to provide a gamma group that is selected among a plurality of gamma groups each including a plurality of gamma data to the data driving unit, and to provide dimming data corresponding to the selected gamma group to the emission control unit.

In example embodiments, the luminance control unit may be electrically connected to the data driving unit, or located in the data driving unit.

In example embodiments, the luminance control unit may include a gamma group selecting unit configured to receive luminance data to be displayed on the display panel from an external device, and to select the gamma group corresponding to the luminance data among the plurality of gamma groups each including the plurality of gamma data, a gamma group storing unit configured to store the gamma groups, and a dimming data storing unit configured to store the dimming data corresponding to each of the gamma groups.

In example embodiments, the luminance data may be data by which a maximum luminance is displayed on the display panel.

In example embodiments, the selected gamma group may be a gamma group of which a feasible maximum luminance corresponds to the luminance data among the gamma groups.

In example embodiments, a dimming operation of the display panel may be performed based on the dimming data, and the dimming data may be an off duty ratio that controls a light emission time of the organic light-emitting diode.

In example embodiments, the dimming operation may correspond to a global dimming operation, and the dimming operation may be simultaneously performed on an entire region of the display panel.

In example embodiments, the dimming operation may correspond to a local dimming operation, and the dimming operation is separately performed on respective regions of the display panel.

Another aspect is a method of controlling a luminance of a display device, the method comprising receiving luminance data to be displayed on a display panel, selecting a gamma group corresponding to the luminance data among a plurality of gamma groups, wherein each gamma group includes gamma data, retrieving dimming data corresponding to the selected gamma group, and outputting the selected gamma group to a data driver and the dimming data to an emission controller.

In the above method, the luminance data comprises data by which the maximum luminance is displayed on the display panel. In the above method, the maximum luminance of the selected gamma group corresponds to the luminance data. In the above method, a dimming operation of the display panel is performed based at least partially on the dimming data, and the dimming data is an off duty ratio that controls a light emission time of the display panel. In the above method, the dimming operation corresponds to a global dimming operation, and the dimming operation is substantially simultaneously performed on substantially the entire region of the display panel. In the above method, the dimming operation corresponds to a local dimming operation, and the dimming operation is separately performed on respective regions of the display panel.

Another aspect is a luminance controller for a display device, comprising a gamma group selector, a gamma group memory, and a dimming data memory. The gamma group selector is configured to receive luminance data to be displayed on a display panel, and to select a gamma group corresponding to the luminance data among a plurality of gamma groups, wherein each gamma group includes a plurality of gamma data. The gamma group memory stores the gamma groups. The dimming data memory stores a plurality of dimming data respectively corresponding to the gamma groups.

In the above luminance controller, the luminance data comprises data by which the maximum luminance is displayed on the display panel. In the above luminance controller, the maximum luminance of the selected gamma corresponds to the luminance data. In the above luminance controller, a dimming operation of the display panel is configured to be performed based at least partially on the dimming data, and the dimming data is an off duty ratio configured to control a light emission time of the display panel.

Another aspect is an organic light-emitting diode (OLED) display, comprising a display panel, a data driver, a scan driver, an emission controller, a power supply, a timing controller, and a luminance controller. The display panel includes a plurality of pixels, wherein each pixel includes an OLED. The data driver is configured to provide a data signal to the pixels. The scan driver is configured to provide a scan signal to the pixels. The emission controller is configured to provide an emission control signal to the pixels. The power supply is configured to provide a first power voltage and a second power voltage to the pixels, wherein the first and second power voltages are different from each other. The timing controller is configured to control the scan driver, the data driver, the emission controller, and the power supply. The luminance controller is configured to select a gamma group among a plurality of gamma groups and provide the selected gamma group to the data driver, and to provide dimming data corresponding to the selected gamma group to the emission controller, wherein each gamma group includes gamma data.

In the above OLED display, the luminance controller is electrically connected to the data driver, or located in the data driver. In the above OLED display, the luminance controller includes a gamma group selector configured to receive luminance data to be displayed on the display panel, and to select the gamma group corresponding to the luminance data among the gamma groups. In the above OLED display, the luminance controller also includes a gamma group memory storing the gamma groups and a dimming data memory storing the dimming data.

In the above OLED display, the luminance data comprises data by which the maximum luminance is displayed on the display panel. In the above OLED display, the maximum luminance of the selected gamma group corresponds to the luminance data. In the above OLED display, the luminance controller is configured to perform a dimming operation of the display panel based at least partially on the dimming data, and the dimming data is an off duty ratio configured to control a light emission time of the OLED.

In the above OLED display, the dimming operation corresponds to a global dimming operation, and the luminance controller is configured to perform the dimming operation substantially simultaneously on substantially the entire region of the display panel. In the above OLED display, the dimming operation corresponds to a local dimming operation, and the luminance controller is configured to perform the dimming operation separately on respective regions of the display panel.

Another aspect is a luminance controller for a display device, the luminance controller comprising a memory, a gamma group unit, and a dimming unit. The memory stores a plurality of gamma groups. The gamma group unit is configured to receive luminance data to be displayed on a display panel, select a gamma group corresponding to the luminance data from the memory, and output the selected gamma group. The dimming data unit is configured to output dimming data to each gamma group.

In the above luminance controller, the luminance data comprises data by which the maximum luminance is displayed on the display panel. In the above luminance controller, the dimming data is an off duty ratio configured to control a light emission time of an organic light-emitting diode (OLED) of the display device.

According to at least one embodiment, since the dimming technique causes color changes such as a gamma curve deformation and a color coordinate abnormality, an image quality of the organic light emitting display device may be degraded. A method of controlling a luminance, a luminance control unit, and an organic light-emitting display device having the luminance control unit according to example embodiments can perform a subdivided dimming operation by providing a gamma group and a dimming data that correspond to each luminance when the luminance of the organic light-emitting display device is changed. As a result, the image quality of the organic light-emitting display device may be improved.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of controlling a luminance according to example embodiments.

FIG. 2 is a circuit diagram illustrating a pixel included in an organic light-emitting display device employing the method of FIG. 1.

FIG. 3 is a block diagram illustrating a luminance control unit according to example embodiments.

FIG. 4 is a block diagram illustrating a gamma group storing unit and a dimming data storing unit included in the luminance control unit of FIG. 3.

FIGS. 5A through 5C are graphs illustrating an example of gamma groups and dimming data that are stored in the gamma group storing unit and the dimming data storing unit of FIG. 4.

FIG. 6 is a block diagram illustrating an organic light-emitting display device according to example embodiments.

FIG. 7 is a block diagram illustrating an electronic device having the organic light-emitting display device of FIG. 6.

FIG. 8 is a diagram illustrating an example in which the electronic device of FIG. 7 is implemented as a smartphone.

### DETAILED DESCRIPTION OF CERTAIN INVENTIVE EMBODIMENTS

Hereinafter, the described technology will be explained in detail with reference to the accompanying drawings.

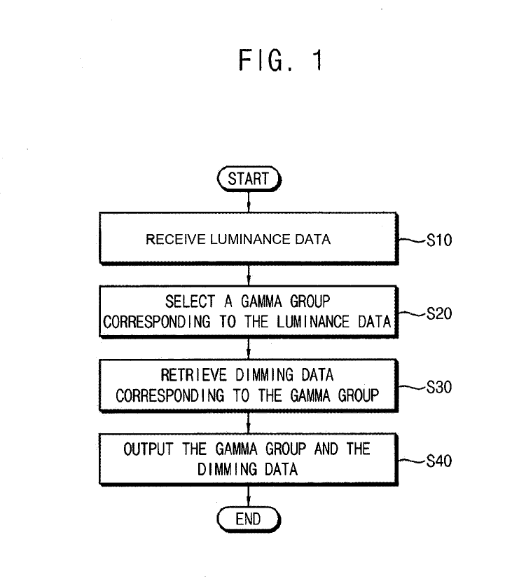

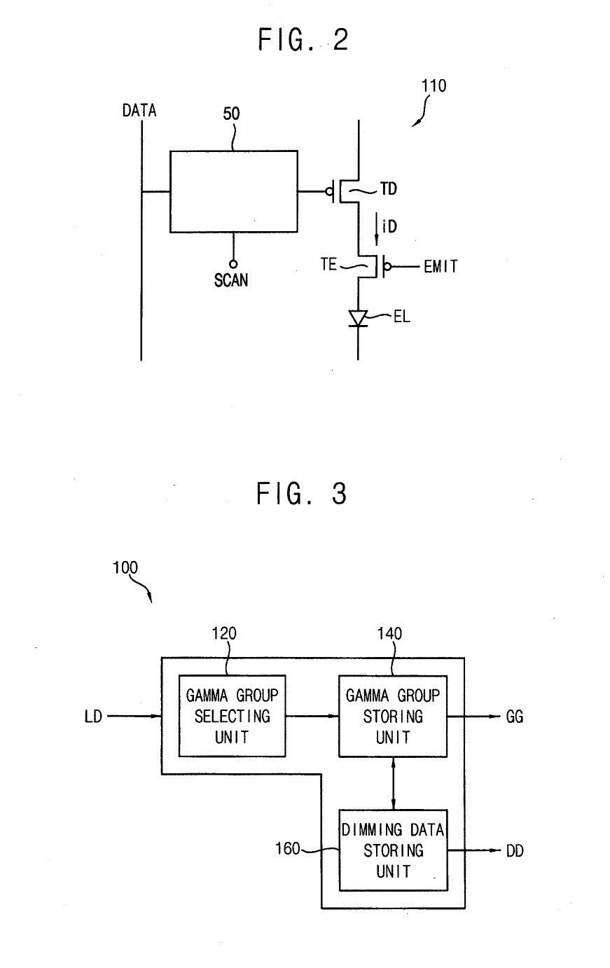

FIG. 1 is a flowchart illustrating a method of controlling a luminance according to example embodiments. FIG. 2 is a circuit diagram illustrating a pixel 110 included in an organic light-emitting diode (OLED) display (or organic light-emitting display device) employing the method of FIG. 1.

In some embodiments, the FIG. 1 procedure is implemented in a conventional programming language, such as C or C++ or another suitable programming language. The program can be stored on a computer accessible storage medium of the OLED display, for example, a memory (not shown) of the OLED display or a luminance controller 100. In certain embodiments, the storage medium includes a random access memory (RAM), hard disks, floppy disks, digital video devices, compact discs, video discs, and/or other optical storage mediums, etc. The program may be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/Vista/2000/9x/ME/XP, Macintosh OS, OS/2, Android, iOS and the like. In another embodiment, at least part of the procedure can be implemented with embedded software. Depending on the embodiment, additional states may be added, others removed, or the order of the states changed in FIG. 1.

Referring to FIG. 1, the method of FIG. 1 can receive luminance data to be displayed on a display panel from an external device (S10), and can select a gamma group corresponding to the luminance data among a plurality of gamma groups each including a plurality of gamma data (S20). Subsequently, the method of FIG. 1 can import dimming data corresponding to the selected gamma group (S30), and can output the selected gamma group to a data driving unit or data driver and the dimming data to an emission control unit or controller (S40).

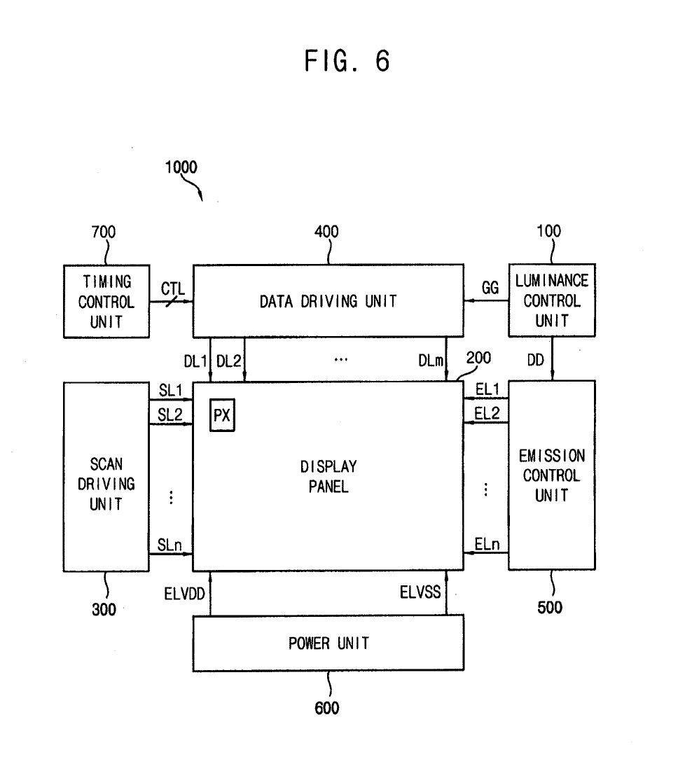

Referring to FIG. 2, the pixel 110 can include a switching circuit 50, a driving transistor TD, a light emission control transistor TE, and an organic light-emitting diode (OLED) EL. The switching circuit 50 can apply a data signal DATA that is applied through a data line (see FIG. 6) to the driving transistor TD in response to a scan signal SCAN that is applied though a scan line (see FIG. 6). The structure of the switching circuit 50 can vary. For example, the switching circuit 50 can include a switching transistor and a storage capacitor that are electrically connected to the data line and scan line. The driving transistor TD can control a driving current iD that flows through the driving transistor TD and the organic light-emitting diode EL according to the data signal DATA received from the switching circuit 50. For example, a luminance of the organic light-emitting diode EL can be controlled according to a value of the driving current iD. The light emission control transistor TE can be electrically connected to the driving transistor TD and the organic light-emitting diode EL. The light emission control transistor TE can control the luminance of the organic light-emitting diode EL. For example, when the light emission control transistor TE is turned on in response to an emission control signal EMIT applied through an emission control line (not shown). The driving current iD can be applied to the organic light-emitting diode EL, and thus the organic light-emitting diode EL can emit light. In some embodiments, the light emission control transistor TE is tuned off, the driving current iD is not applied to the organic light-emitting diode EL, and thus the organic light-emitting diode EL does not emit the light. As described above, the luminance of the organic light-emitting display device can be determined by the value of the driving current iD and a turn-on time of the light emission control transistor TE.

The method of FIG. 1 can select the gamma group corresponding to the luminance data, and can apply the gamma group to the data driving unit that provides the data signal DATA to the pixel 110 of the organic light-emitting display device. The method of FIG. 1 can import the dimming data corresponding to the selected gamma group, and can apply the dimming data to the emission control unit that provides the emission control signal EMIT to the pixel 110. Hereinafter, the method of FIG. 1 will be described in detail.

The method of FIG. 1 can receive the luminance data from the external device (S10). Here, the luminance data can be data by which a maximum luminance is displayed on the display panel. The luminance data can be applied in a luminance range that can be displayed on the display panel. For example, when the maximum luminance of the organic light-emitting display device is about 300 nit, the luminance data can be selected in the luminance range between about 0 nit and about 300 nit.

The method of FIG. 1 can select the gamma group based on the luminance data (S20). For example, the gamma group can be determined by selecting the gamma group of which the maximum luminance corresponds to the luminance data among the gamma groups that are stored, for example, in a look-up table. Here, the look-up table can include the gamma groups each including the gamma data corresponding to each grayscale. The look-up table can be implemented by any storage device that can store the gamma groups.

The method of FIG. 1 can import the dimming data corresponding to the selected gamma group (S30). For example, the method of FIG. 1 can import the dimming data by selecting the dimming data corresponding to the gamma group using the look-up table. Here, the look-up table can include a plurality of dimming data corresponding to each of gamma groups. As described above, when the luminance data to be displayed on the display panel is received, the gamma group and the dimming data that correspond to the luminance data can be selected using the look-up table.

The method of FIG. 1 can output the selected gamma group to the data driving unit, and can output the dimming data to the emission control unit (S40). The data driving unit can generate the data signal DATA based on the gamma group. The emission control unit can generate the emission control signal EMIT based on the dimming data. The organic light-emitting diode EL can perform the dimming operation based on the emission control signal EMIT. In some example embodiments, the dimming operation can correspond to a global dimming operation, and can be substantially simultaneously performed on substantially the entire region of the display panel. In other example embodiments, the dimming operation can correspond to a local dimming operation, and can be separately performed on respective regions of the display panel.

As described above, the method of FIG. 1 can perform a subdivided dimming operation by selecting the gamma group corresponding to the luminance data and the dimming data corresponding to the gamma group in the organic light-emitting display device. Thus, the method of FIG. 1 can change the dimming data to display the luminance in a high-luminance region or a low-luminance region. Therefore, the method of FIG. 1 can allow the organic light-emitting display device to display a high-quality image compared to typical dimming methods of which the dimming data is sequentially (e.g., linearly or non-linearly) increased when the luminance is changed from the high-luminance region to the low-luminance region.

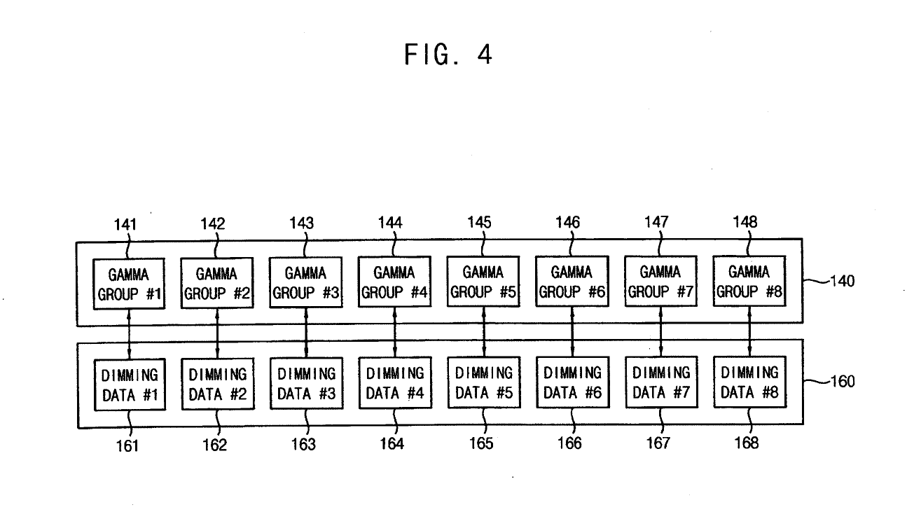

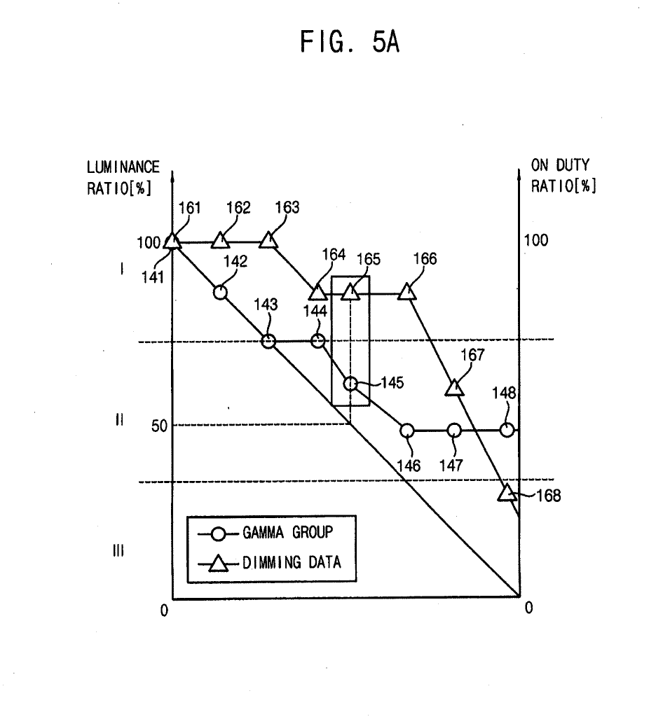

FIG. 3 is a block diagram illustrating a luminance control unit or luminance controller 100 according to example embodiments. FIG. 4 is a block diagram illustrating a gamma group storing unit 140 and a dimming data storing unit 160 included in the luminance control unit 100 of FIG. 3.

Referring to FIG. 3, the luminance control unit 100 can include a gamma group selecting unit or gamma group selector 120, a gamma group storing unit or gamma group memory 140, and a dimming data storing unit or dimming data memory 160. The gamma group selecting unit 120 can receive the luminance data LD to be displayed on the display panel. Here, the luminance data LD can be data by which the maximum luminance is displayed on the display panel. The luminance data LD can be applied in the luminance range. For example, when the maximum luminance is about 300 nit, the luminance data LD can be selected in the luminance range between about 0 nit and about 300 nit. The gamma group selecting unit 120 can select the gamma group of which the maximum luminance corresponds to the luminance data LD among the gamma groups. The gamma group GG can be output from the gamma group storing unit 140.

Referring to FIG. 4, the gamma group storing unit 140 can include first through eighth gamma groups 141, 142, 143, 144, 145, 146, 147, and 148. Each of the gamma groups 141-148 can store the gamma data corresponding to each grayscale. For example, when an organic light-emitting display device is driven by 8 bits, each gamma group 141-148 can store the gamma data corresponding to grayscales of 0 through 255. The gamma groups 141-148 and dimming data 161, 162, 163, 164, 165, 166, 167, and 168 can be applied to the pixel 110 through a data driving unit and an emission control unit. Here, the luminance to be displayed on the display panel can be determined by the gamma groups 141-148 and the dimming data 161-168. The gamma data can be predetermined experimental values that can optimize the display quality of the organic light-emitting display device. The gamma groups that are adjacent to each other can be linearly connected based on an interpolation. Although the eight gamma groups 141-148 are illustrated in FIG. 4, the number of gamma groups is not limited thereto.

The gamma group selecting unit 120 can select one of the gamma groups 141-148 of which the maximum luminance corresponds to the luminance data LD. The dimming data storing unit 160 can store first through eighth dimming data 161-168 that correspond to the each of the first through eighth gamma groups 141-148, respectively. The dimming data 161-168 can include an off duty ratio that is a turn-off time ratio of the organic light-emitting diode EL. Each dimming data 161-168 can have substantially an equal off duty ratio or an unequal off duty ratio. As described above, since the luminance of the organic light-emitting display device can be determined by the gamma groups 141-148 and the dimming data 161-168, a different luminance can be displayed on the display panel when the gamma data of the gamma groups 141-148 are unequal although the dimming data 161-168 are substantially equal. The dimming data 161-168 can be linearly connected based on the interpolation. Although the eight dimming data 161-168 are illustrated in FIG. 4, the number of the dimming data can change according to the number of the gamma groups.

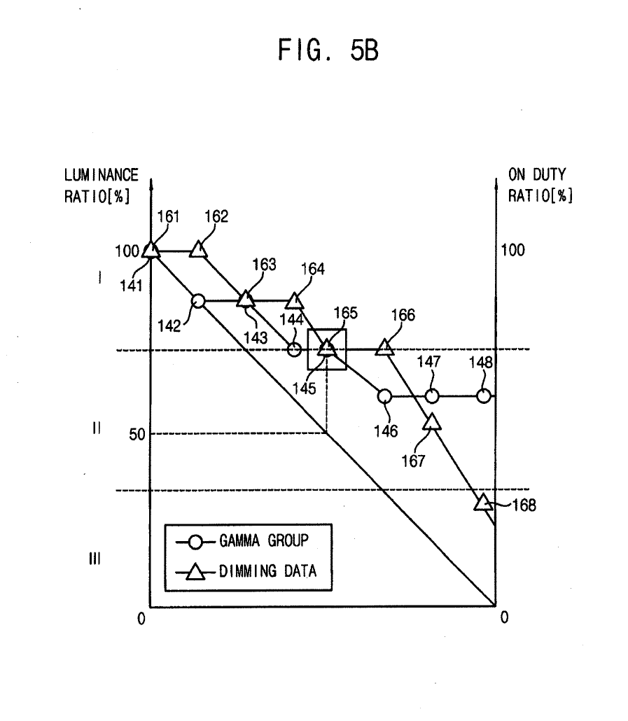

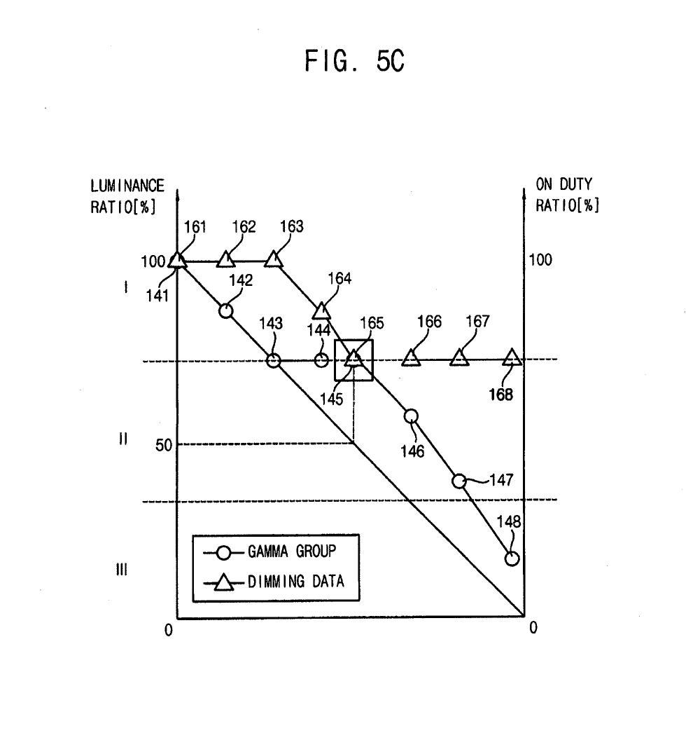

FIGS. 5A through 5C are graphs illustrating examples of gamma groups and dimming data of FIG. 4. The graphs of FIGS. 5A through 5C can represent the gamma groups 141-148 and the dimming data 161-168 to display luminance in the high-luminance region I, a mid-luminance region II, and the low-luminance region III.

Referring to FIGS. 5A through 5C, a subdivided dimming operation can be performed by substantially equally or unequally setting the dimming data (i.e., off duty ratio).

Referring to FIG. 5A, the first through third gamma groups 141, 142, and 143 and the first through third dimming data 161, 162, and 163 can display the luminance in the high-luminance region I. The first through third dimming data 161-163 that display the luminance in the high-luminance region I can be substantially equal. The off duty ratio of the first through third dimming data 161-163 can be substantially equal to 0% (i.e., on duty ratio of 100%). Although the off duty ratio of the first through third dimming data 161-163 are substantially equal, the different luminance can be displayed on the display panel because the first through third gamma groups 141-143 have unequal luminance. Each of the gamma groups 141-143 can include gamma data that allow the display panel to display optimized color with the dimming data 161-163. For example, the gamma data can have a 2.2 gamma curve. When the dimming operation is performed to display the luminance in the high-luminance region I, the driving current iD can increase to compensate for the decreased luminance caused by the dimming operation. Thus, when the dimming operation is performed to display the luminance in the high-luminance region I, power consumption of the organic light-emitting diode EL can decrease, and the lifespan of the organic light-emitting diode EL can increase by setting the off duty ratio to about 0% (i.e., on duty ratio of about 100%).

The fourth through sixth gamma groups 144, 145, and 146 and the fourth through sixth dimming data 164, 165, and 166 can display the luminance in the mid-luminance region II. The off duty ratio of the fourth through sixth dimming data 164-166 can be higher (i.e., the on duty ratio can be lower) than the off duty ratio of the first through third dimming data 161-163. The off duty ratio of the fourth through sixth dimming data 164-166 can be substantially equal. Although the off duty ratio of the fourth through sixth dimming data 164-166 are substantially equal, the different luminance can be displayed on the display panel because the fourth through sixth gamma groups 144-146 have unequal luminance. Each of the gamma groups 144-146 can include gamma data that allow the organic light-emitting display device to display optimized color with dimming data 164-166. For example, the gamma data can have the 2.2 gamma curve.

The seventh and eighth gamma groups 147 and 148 and the seventh and eighth dimming data 167 and 168 can display the luminance in the low-luminance region III. The off duty ratio of the seventh and eighth dimming data 167-168 can be higher (i.e., the on duty ratio can be lower) than the off duty ratio of the fourth through sixth dimming data 164-166. The off duty ratio of the eighth dimming data 168 can be higher than the off duty ratio of the seventh dimming data 167 (i.e., the on duty ratio of the eighth dimming data 168 can be lower than the on duty ratio of the seventh dimming data 167). Each of the seventh and eighth gamma groups 147-148 can have the gamma data. The gamma data allows the organic light-emitting display device to display optimized color with dimming data 167-168. For example, the gamma data can have the 2.2 gamma curve. When the off duty ratio of the organic light-emitting diode EL increases (i.e., the on duty ratio decreases), the organic light-emitting display device can have lower power consumption, a reduced level of staining, and a reduced degree of image sticking. As described above, the luminance control unit 100 can perform the subdivided dimming operation according to the luminance region by storing, selecting, and outputting the gamma data with the dimming data 161-168.

As described in FIGS. 5A through 5C, the luminance control unit 100 can store the gamma groups 141-148 that are different and the dimming data 161-168 that are different. For example, the luminance control unit 100 that receives the luminance data LD corresponding to about 50% of the maximum luminance of the organic light-emitting display device can select and output the fifth gamma group 145 and the fifth dimming data 165 corresponding to the fifth gamma group 145. The fifth gamma group 145 can be provided to the data driving unit, and the fifth dimming data 165 can be provided to the emission control unit. The data driving unit can generate a data signal DATA based on the fifth gamma group 145, and can provide the data signal DATA to the pixels 110 of the display panel. The driving current iD can be controlled by the data signal DATA. The emission control unit can generate the emission control signal EMIT based on the fifth dimming data 165, and can provide the emission control signal EMIT to the pixels PX. A light emission time of the organic light-emitting diodes EL can be controlled by the emission control signal EMIT. Thus, the luminance corresponding to about half of the maximum luminance can be displayed by the fifth gamma group 145 and the fifth dimming data 165. The gamma groups 141-148 and the dimming data 161-168 can vary according to the property of the organic light-emitting display device.

FIG. 6 is a block diagram illustrating an organic light-emitting display device 1000 according to example embodiments.

Referring to FIG. 6, the organic light-emitting display device 1000 can include the display panel 200, a scan driving unit or scan driver 300, a data driving unit or data driver 400, an emission control unit or emission controller 500, a power unit or power supply 600, a timing control unit or timing controller 700, and a luminance control unit or luminance controller 100.

The display panel 200 includes pixels PX. The description of the pixel PX will not be repeated because it is described with reference to FIG. 2. The scan driving unit 300 can provide the scan signal SCAN to the pixels PX via a plurality of scan lines SL1 through SLn. The data driving unit 400 can provide the data signal DATA to the pixels PX via a plurality of data lines DL1 through DLm according to the scan signal SCAN. The data signal DATA can be generated based on the gamma group GG. The emission control unit 500 can provide the emission control signal EMIT to the pixels PX via a plurality of emission control lines EL1 through ELn. The emission control signal EMIT can be generated based on the dimming data DD. The power unit 100 can provide a high power voltage ELVDD and a low power voltage ELVSS to the pixels PX. The timing control unit 700 can generate a plurality of control signals CTL to control the scan driving unit 300, the data driving unit 400, the emission control unit 500, the power unit 600, and the luminance control unit 100. The luminance control unit 100 can control the luminance that is displayed on the display panel 200 based on the luminance data LD. In some example embodiments, the luminance control unit 100 can be located within the data driving unit 400. In other example embodiments, the luminance control unit 100 can be electrically connected to the data driving unit 400.

As described above, the luminance control unit 100 can perform a subdivided dimming operation by selecting the gamma group GG and the dimming data DD in the organic light-emitting display device 1000. Thus, the organic light-emitting display device 1000 can change the dimming data to display luminance in the high-luminance I region or the low-luminance region III. Therefore, the organic light-emitting display device 1000 can display a high-quality image compared to typical OLED displays of which the dimming data sequentially (e.g., linearly or non-linearly) increased when the luminance changes from the high-luminance region I to the low-luminance region III.

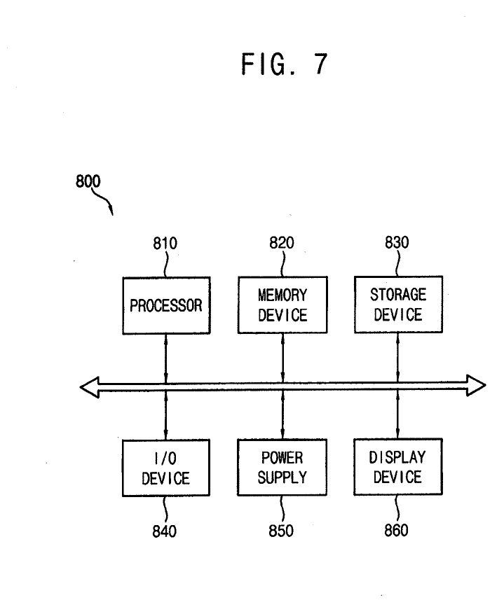

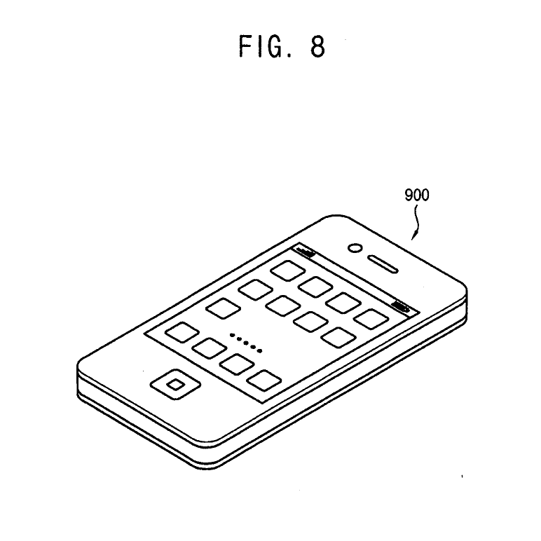

FIG. 7 is a block diagram illustrating an electronic device 800 having the organic light-emitting display device 1000 of FIG. 6. FIG. 8 is a diagram illustrating an example in which the electronic device 800 of FIG. 7 is implemented as a smartphone 900.

Referring to FIG. 7, the electronic device 800 can include a processor 810, a memory device 820, a storage device 830, an input/output (I/O) device 840, a power supply 850 and a display device (e.g., OLED display) 860. Here, the display device 860 can correspond to the organic light-emitting display device 1000 of FIG. 6. In addition, the electronic device 800 can further include a plurality of ports for communicating one or more of a video card, a sound card, a memory card, a universal serial bus (USB) device and other electronic devices, etc. Although the electronic device 800 is implemented as the smartphone 900 in FIG. 8, it is not limited thereto. For example, the electronic device 800 can be a laptop computer, a tablet computer, a personal digital assistant (PDA), a portable multimedia player (PMP), a smart watch, or other personal display devices.

The processor 810 can perform various computing functions. The processor 810 can be a microprocessor, a central processing unit (CPU), etc. The processor 810 can be electrically connected to other components via an address bus, a control bus, a data bus, etc. Further, the processor 810 can be electrically connected to an extended bus such as a peripheral component interconnect (PCI) bus. The memory device 820 can store data for operations of the electronic device 600. For example, the memory device 820 can include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device or a mobile DRAM device, etc. The storage device 830 can be a solid state drive (SSD) device, a hard disk drive (HDD) device or a CD-ROM device, etc.

The I/O device 840 can be an input device such as a keyboard, a keypad, a touchpad, a touch-screen or a mouse, etc., and an output device such as a printer or a speaker, etc. In some example embodiments, the display device 860 can be included in the I/O device 840. The power supply 850 can provide power for operations of the electronic device 800. The display device 860 can communicate with other components via the buses or other communication links. The display device 860 can include the luminance control unit 100. The luminance control unit 100 can include the gamma group selecting unit 120, the gamma group storing unit 140, and the dimming data storing unit 160. The luminance controller 100, the gamma group selecting unit 120, the gamma group storing unit 140, and the dimming storing unit 160 can operate as described above.

The described technology can be applied to an electronic device having a display device such as an OLED display. For example, the described technology can be applied to a computer monitor, a laptop, a digital camera, a cellular phone, a smart phone, a smart pad, a television, a personal digital assistant (PDA), a portable multimedia player (PMP), a MP3 player, a navigation system, a game console or a video phone, etc.

The above description is illustrative of example embodiments and is not to be construed as limiting thereof. Although a few example embodiments have been described, those skilled in the art will readily appreciate that many modifications are possible in the example embodiments without materially departing from the novel teachings and advantages of the described technology. Accordingly, all such modifications are intended to be included within the scope of the described technology as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of controlling a luminance of a display device, the method comprising:
receiving luminance data to be displayed on a display panel;
selecting a gamma group corresponding to the luminance data among a plurality of gamma groups, wherein each gamma group includes gamma data;
retrieving dimming data corresponding to the selected gamma group; and
outputting the selected gamma group to a data driver and the dimming data to an emission controller.

2. The method of claim 1, wherein the luminance data comprises data by which the maximum luminance is displayed on the display panel.

3. The method of claim 1, wherein the maximum luminance of the selected gamma group corresponds to the luminance data.

4. The method of claim 1, wherein a dimming operation of the display panel is performed based at least partially on the dimming data, and
wherein the dimming data is an off duty ratio that controls a light emission time of the display panel.

5. The method of claim 4, wherein the dimming operation corresponds to a global dimming operation, and
wherein the dimming operation is substantially simultaneously performed on substantially the entire region of the display panel.

6. The method of claim 4, wherein the dimming operation corresponds to a local dimming operation, and
wherein the dimming operation is separately performed on respective regions of the display panel.

7. A luminance controller for a display device, comprising:
a gamma group selector configured to receive luminance data to be displayed on a display panel, and to select a gamma group corresponding to the luminance data among a plurality of gamma groups, wherein each gamma group includes a plurality of gamma data;
a gamma group memory storing the gamma groups; and
a dimming data memory storing a plurality of dimming data respectively corresponding to the gamma groups.

8. The luminance controller of claim 7, wherein the luminance data comprises data by which the maximum luminance is displayed on the display panel.

9. The luminance controller of claim 7, wherein the maximum luminance of the selected gamma corresponds to the luminance data.

10. The luminance controller of claim 7, wherein a dimming operation of the display panel is configured to be performed based at least partially on the dimming data, and
wherein the dimming data is an off duty ratio configured to control a light emission time of the display panel.

11. An organic light-emitting diode (OLED) display, comprising:
a display panel that includes a plurality of pixels, wherein each pixel includes an OLED;
a data driver configured to provide a data signal to the pixels;
a scan driver configured to provide a scan signal to the pixels;
an emission controller configured to provide an emission control signal to the pixels;
a power supply configured to provide a first power voltage and a second power voltage to the pixels, wherein the first and second power voltages are different from each other;
a timing controller configured to control the scan driver, the data driver, the emission controller, and the power supply; and
a luminance controller configured to select a gamma group among a plurality of gamma groups and provide the selected gamma group to the data driver, and to provide dimming data corresponding to the selected gamma group to the emission controller, wherein each gamma group includes gamma data.

12. The OLED display of claim 11, wherein the luminance controller is electrically connected to the data driver, or located in the data driver.

13. The OLED display of claim 11, wherein the luminance controller includes:
a gamma group selector configured to receive luminance data to be displayed on the display panel, and to select the gamma group corresponding to the luminance data among the gamma groups;
a gamma group memory storing the gamma groups; and
a dimming data memory storing the dimming data.

14. The OLED display of claim 13, wherein the luminance data comprises data by which the maximum luminance is displayed on the display panel.

15. The OLED display of claim 13, wherein the maximum luminance of the selected gamma group corresponds to the luminance data.

16. The OLED display of claim 13, wherein the luminance controller is configured to perform a dimming operation of the display panel based at least partially on the dimming data, and
wherein the dimming data is an off duty ratio configured to control a light emission time of the OLED.

17. The OLED display of claim 16, wherein the dimming operation corresponds to a global dimming operation, and
wherein the luminance controller is configured to perform the dimming operation substantially simultaneously on substantially the entire region of the display panel.

18. The OLED display of claim 16, wherein the dimming operation corresponds to a local dimming operation, and
wherein the luminance controller is configured to perform the dimming operation separately on respective regions of the display panel.
